(19) United States
(12) Patent Application Publication
(10) Pub. No.: US 2026/0223037 A1
(43) Pub. Date: Jul. 30, 2026

(54) SYSTEM AND METHOD FOR REGISTERING RADIO UNITS IN WIRELESS NETWORKS

(71) Applicant: JOHN MEZZALINGUA ASSOCIATES, LLC., Liverpool, NY (US)

(72) Inventors: Todd Edward LANDRY, Grayslake, IL (US); Darrin DAVIS, Severn, MD (US); Waqqas SUBHANI

(21) Appl. No.: 18/834,899

(22) PCT Filed: Jul. 18, 2024
(86) PCT No.: PCT/US2024/038578

§ 371 Date: Jul. 31, 2024

Related U.S. Application Data
(60) Provisional application No. 63/514,420, filed on Jul. 19, 2023.

(51) Int. Cl. H04W 64/00; H04W 4/80

(52) U.S. Cl. CPC H04W 64/00; H04W 4/80

(57) ABSTRACT

A method for registering a plurality of Radio Remote Units (RUs) in a Radio Access Network (RAN) greatly simplifies the acquisition and logging of information about each RU in a RAN deployment. Each RU has a radome with a measuring plane that enables a information capture device to be affixed to it so that the location and orientation of the RU may be measured. Disposed on the radome is a QR Code that, once imaged by the information capture device, enables the information capture device to obtain all necessary information about the RU for its deployment. This information may include that which is required for a central server to submit a grant request to a CBRS SAS (Citizen Broadband Radio Service Spectrum Allocation Service) so that each of the RUs may be granted access to CBRS channels as a CBSD (CBRS Device).

### BACKGROUND OF THE INVENTION

Deploying a RAN (Radio Access Network) in a venue, such as a stadium or university campus, requires many radio units (RUs) and their associated antennas to be installed in the correct location and orientation to provide consistent coverage throughout the venue.

FIG. 1 illustrates a simplified version of a RAN deployment 100 in a stadium. The stadium deployment 100 has a plurality of RUs and antennas 110, each of which having a gain pattern 115. The RUs 110 are positioned and oriented so that their respective gain patterns 115 substantially fill the area of the stadium 100 with an acceptable degree of overlap. The locations and orientations of the RUs are determined by the RF (Radio Frequency) design for the cellular deployment 100 within the stadium.

Each RU 110 must be mounted such that each is positioned and oriented according to the RF design. Accordingly, once installed, each RU 110 must be registered so that not only its position and orientation is logged, including measurement accuracy, but its individual capabilities (e.g., frequency bands, Max EIRP (Equivalent Isotropic Radiated Power), antenna gain, FCC ID, etc.) must be obtained and logged. Under conventional methods, this is a labor intensive exercise that often has installers estimating or using various tools of choice to capture the information. Moreover, the process of entering the information into a system database is typically a manual process. As such, not only is the conventional approach labor intensive and thus expensive to implement, but it is also prone to errors.

Accordingly, what is needed is a system and method for registering a plurality of RUs within a given deployment that is simplified yet not vulnerable to mistakes and subsequent errors.

### SUMMARY OF THE INVENTION

An aspect of the disclosure involves a method for registering a plurality of RUs (Radio Units) in a RAN (Radio Access Network) deployment. The method at least comprises mounting a plurality of RUS, each at a designated location according to an RF (Radio Frequency) design. Each of the RUs is further placed in an orientation according to the RF design. The method then involves measuring an RU location and RU orientation for each of the plurality of RUs. Further, RU-specific information is obtained for each of the plurality of RUs from an information device mechanically coupled to each RU. For each of the plurality of RUs, the RU location, the RU orientation, and the RU-specific information are recorded.

Another aspect of the disclosure involves a Radio Unit (RU) for a Radio Access Network (RAN). The RU at least comprises a radio having an antenna assembly; a radome mechanically coupled to the radio and configured to conceal the antenna assembly, the radome having a measuring plane disposed on a surface of the radome, and configured to align with an information capture device, allowing the information capture device to obtain a location measurement and an orientation measurement for the RU; an information device mechanically coupled to the RU configured to provide RU-specific information; and an articulating mount mechanically coupled to the RU and configured to orient the RU based on the measured RU location and RU orientation, the RU-specific information and a radio frequency design.

### BRIEF DESCRIPTION OF DRAWINGS

FIG. 1 illustrates a hypothetical RAN deployment in a stadium.

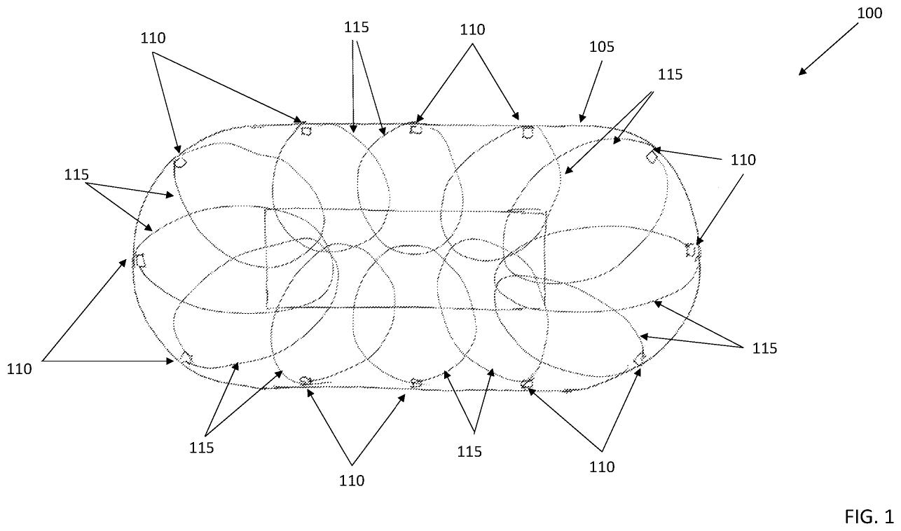

FIG. 2 illustrates an exemplary RU according to the disclosure, showing how a technician may use an information capture device to measure the position and orientation of the RU.

FIG. 3 illustrates an exemplary process for measuring and obtaining information for each deployed RU and to log the information in accordance with the disclosure.

### DETAILED DESCRIPTION OF THE INVENTION

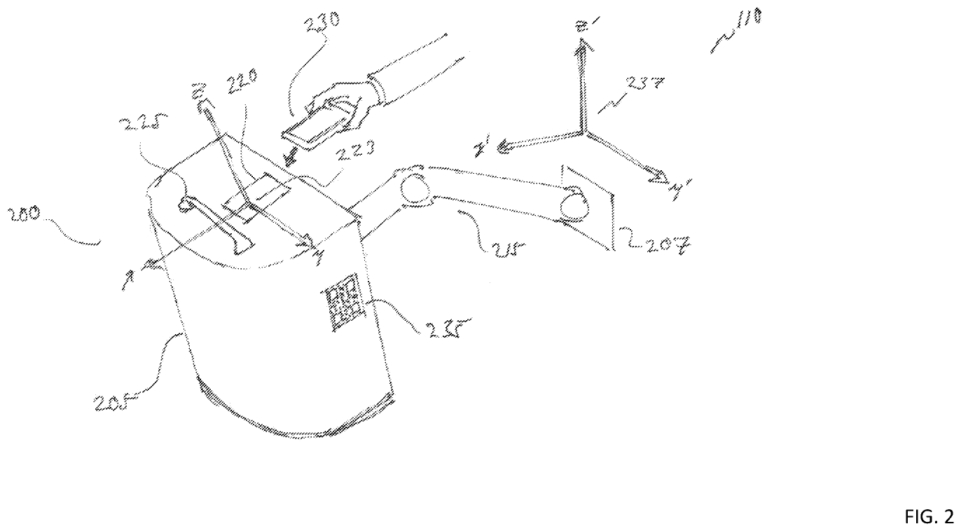

FIG. 2 illustrates an exemplary RU (Radio Unit) 110 according to the disclosure. RU 110 has a radio 200 that has an antenna assembly that is contained within a radome 205. The antenna assembly may include multiple arrays of dipoles, wherein each array of dipoles is configured to radiate in a specific frequency band supported by radio 200. In an example, the antenna assembly may include three dipole arrays: one configured to radiate in the low band (LB) (617-860 MHz), another in the mid band (MB)(1695-2690 MHz), and another in C-Band and CBRS (Citizens Broadband Radio Service)(3.4-4.2 GHz). Further to this example, each of the dipole arrays may be configured to radiate in a 30 degree azimuth gain pattern, providing for 30 degree sector coverage in each band, although other gain patterns are possible and within the scope of the disclosure.

RU 110 may have a measuring plane 220, which may be a flat surface disposed on radome 205. Measuring plane 220 may be configured such that its plane is parallel to the plane defined by the x-axis and the y-axis of radio coordinate axes 223 and is perpendicular to its z-axis. Measurement plane 220 may have an axis (boresight axis) that is parallel to a boresight of the antenna assembly. Radome 205 may also have a handle 225, which may enable RU 110 to be positioned at the desired orientation.

RU 110 may further have a QR code 235 affixed to a convenient location on radome 205. QR code may contain information about radio 200, its identifying information, and its capabilities. Examples of information encoded in QR code 235 may include its supported frequency bands, Max EIRP, antenna gain, FCC ID, CBSD (CBRS Device) category (e.g., A or B), radio type, and device type (e.g., indoor/outdoor), for example. Although, as disclosed, the information is encoded in a QR code, it will be understood that this information may be stored by other means, such as a NFC (Near Field Communications) device installed on or within radome 205, or other types of optical information encoding. It will be understood that such variations are possible and within the scope of the disclosure. The QR code 235 and NFC device are examples of an information device that is coupled to RU 110.

RU 110 may be mounted to a mounting plate 207 via an articulated mount 215. Mounting plate 207 may be mounted to a wall or pole within the venue. An example of articulated mount 215 may be a Magic Arm mount offered by Manfrotto, although other articulating mounts may be used. Articulated mount 215 may provide sufficient dexterity for a technician to orient RU 110 to an orientation specified by the RD design. Articulated mount 215 should also be sufficiently rigid and with a clamping mechanism robust enough to orient RU 110 so that it is fixed and stable. Depending on the RF design, RU 110 may be mounted such that radio coordinate axes 223 have a predefined orientation relative to inertial reference axes 237 defined by x′, y′, z′. Such relative orientation may be represented as a transformation matrix or other known mathematical representation.

Also illustrated in FIG. 2 is an information capture device 230. Information capture device 230 may be a conventional smartphone that has sufficient position and inertial measurement capability to allow a technician to use it to measure the location and orientation of RU 110. As illustrated, a technician is in the process of placing information capture device 230 so that it is flush and aligned with measuring plane 220. This may be done by placing information capture device 230 in physical contact with measuring plane 220. Information capture device 230 may have an application installed thereon, herein referred to as a “mobile capture app”. The function performed by the mobile capture app are described further below.

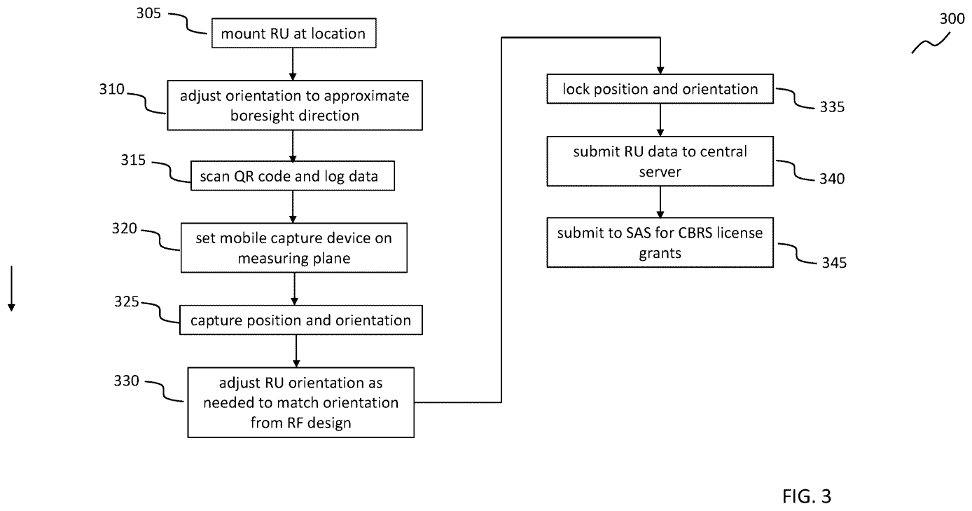

FIG. 3 illustrates an exemplary process 300 for registering a plurality of RUs 110 and requesting one or more CBRS license grants, according to the disclosure. Steps 305-340 may be repeated for each of a plurality of RUs 110 in RAN deployment 100.

In step 305, a technician mounts RU 110 at its designated location according to the RF design. In doing so, the technician may attach mounting plate 207 to an appropriate surface, attach articulated mount 215 to mounting plate 207, and then attach RU 110 to articulated mount 215.

Once in place, in step 310, the technician may orient RU 110 so that it is oriented approximately to its boresight direction as designated in the RF design. In doing so, the technician may have articulated mount 215 set so that RU 110 may be rotated in three degrees of freedom. The technician may then use handle 225 to manipulate RU 110 to its approximate desired orientation and then tighten articulated mount 215 to fix the RU 110 at its interim orientation.

In step 315, the technician may use information capture device 230 to scan QR code 235 to obtain and log information about radio 200, which may include the information listed above. In a variation, instead of a QR Code 235, information may be stored in an NFC device that may be installed within radome 205 under measuring plane 220 such that information capture device 230 may communicate with and retrieve the information from the NFC device while information capture device 230 is placed on measuring plane 220. In either scenario, the mobile capture app running in information capture device 230 may obtain the encoded information and store it as corresponding to the FCC ID or some other device ID corresponding to the particular RU 110. It will be understood that such variations are possible and within the scope of the disclosure.

In step 320, the technician may set information capture device 230 onto measuring plane 220. In doing so, the technician may place information capture device 230 so that it is flush with measuring plane 220 and aligned with the x-axis (or boresight direction) of RU 110. The technician may manually hold information capture device 230 in place. Alternatively, radome 205 may have a clip (not shown) that affixes information capture device 230 to measuring plane 220.

In step 325, information capture device 230 obtains location and orientation information of RU 110 using combination of location and information sources such as GPS, inertial measurement devices, as well as magnetometer, barometer, and other measurement devices native to the device. Information capture device 230 may store this location and orientation information in its memory along with the corresponding information obtained from QR Code 235. In the case of orientation, information capture device 230 may measure the orientation of antenna boresight as represented by radio coordinate axes 223 and convert the orientation information into a transformation matrix relative to inertial reference axis 237.

In step 330, the mobile capture app running in information capture device 230 stores the location and orientation information captured in step 325 and may send it to an offsite database for use in registration, and may, either locally or in the offsite database, compare it to that specified in the RF design. In the case of discrepancy, the technician may loosen articulated mount 215 sufficiently to reorient RU 110—for example, by using handle 225—so that the new measured orientation matches that specified in the RF design. Step 330 may be iterated as needed.

In step 335, the technician may tighten articulated mount 215 to lock RU 110 in the location and orientation established in step 330, which matches that specified in the RF design.

In step 340, the technician may issue a command to the mobile capture app running in information capture device 230 to submit all of the data corresponding to RU 110, including the data obtained from QR Code 235 and the position and orientation measured in process 300, to a central server (not shown). Software running on the central server may store this information, and the received for all of the RUs 110 within deployment 100, by device ID.

In step 345, the central server may compile the information gathered for each RU 110 in repeated iterations of steps 305-340 for submission to a SAS (Spectrum Allocation Service) whereby each RU 110 is to serve as a CBSD (CBRS Device) and operate in one or more CBRS channels. In order to do so, a grant request must be made to the SAS for each RU 110 (as a CBSD). The grant request may require all of some of the information gathered in process 300 cor each CBSD/RU 110.

Although process 300 is described in the context of CBRS: such as RU 110 serving as a CBSD, and interaction with a SAS, it will be understood that this process may pertain to other shared spectrum allocation systems. Further, the disclosed RU 110 and process 300 may be used in other types RAN deployments that might not involve shared spectrum access systems. It will be understood that such variations are possible and within the scope of the disclosure.

1. A method for registering a plurality of RUs (Radio Units) in a RAN (Radio Access Network) deployment, comprising:
mounting a plurality of RUs, each at a designated location according to an RF (Radio Frequency) design;
orienting each of the plurality of RUs according to the RF design;
measuring an RU location and RU orientation of each of the plurality of RUs;
obtaining RU-specific information corresponding to each of the plurality of RUs from an information device mechanically coupled to the RU; and
recording, for each of the plurality of RUs, the RU location, the RU orientation, and RU-specific information.

2. The method of claim 1, wherein the measuring an RU location and RU orientation comprises:
coupling an information capture device to each of the plurality of RUs; and
measuring, with the information capture device, the RU location of each of the plurality of RUs;
and measuring, with the information capture device, the RU orientation of each of the plurality of RUs.

3. The method of claim 2, wherein coupling the information capture device to each of the plurality of RUs comprises:
coupling the information capture device to a measuring plane disposed on each of the plurality of RUs.

4. The method of claim 1, wherein the information device involves a QR code, and wherein obtaining RU-specific information comprises:
taking an image of the QR code with the information capture device; and
extracting the RU-specific information from a website directed to by the QR code; and
recording the RU-specific information.

5. The method of claim 1, wherein the information device involves a near-field communication (NFC) device, and wherein obtaining RU-specific information comprises:
receiving the RU-specific information from the NFC device with the information capture device; and
recording the RU-specific information.

6. The method of claim 1, wherein the RU-specific information comprises RU capability information of a corresponding RU.

7. The method of claim 6, wherein RU capability information includes at least one of an RU supported frequency bands, maximum equivalent isotropic radiated power (EIRP), antenna gain, an FCC ID, a CBRS device category and radio type.

8. The method of claim 1, wherein the orienting each of the plurality of RUs comprises orienting a corresponding one of the plurality of RUs at an interim orientation;
wherein the measuring an RU orientation comprises measuring the interim orientation; and
wherein the method of claim 1 further comprises:
determining a discrepancy between the interim orientation and a desired RU orientation according to the RF design; and
re-orienting the RU to minimize the orientation discrepancy.

9. The method of claim 8, wherein the orienting each of the plurality of RUs further comprises orienting the-corresponding one of the plurality of RUs at an interim location;
wherein the measuring an RU location comprises measuring the interim location; and
wherein the method further comprises:
determining a discrepancy between the interim location and a desired RU location according to the RF design; and
re-orienting the RU to minimize the location discrepancy.

10. The method of claim 1, wherein the recording comprises:
sending the RU location, RU orientation, and RU-specific information for each of the RUs to a central server.

11. The method of claim 1, further comprising:
compiling the RU location, RU orientation, and RU-specific information for each of the RUs; and
submitting a registration grant request corresponding to each of the RUs to a SAS (Spectrum Allocation Service).

12. A Radio Remote Unit (RU) for a Radio Access Network (RAN), comprising:
a radio having an antenna assembly;
a radome mechanically coupled to the radio and configured to conceal the antenna assembly, the radome having a measuring plane disposed on a surface of the radome, and configured to align with an information capture device, allowing the information capture device to obtain a location measurement and an orientation measurement for the RU;
an information device mechanically coupled to the RU configured to provide RU-specific information; and
an articulating mount mechanically coupled to the RU and configured to orient the RU based on the measured RU location and RU orientation, the RU-specific information and a radio frequency design.

13. The RU of claim 12, wherein the information device comprises a QR code disposed on an outer surface of the radome, the QR code being configured to provide the RU-specific information via a corresponding website.

14. The RU of claim 12, wherein the information device comprises a near-field communication device configured to communicate the RU-specific information to the information capture device.

15. The RU of claim 12, further comprising a handle disposed on the radome.

16. The RU of claim 12, wherein the RU-specific information comprises RU capability information.

17. The RU of claim 16, wherein RU capability information includes at least one of an RU supported frequency bands, maximum equivalent isotropic radiated power (EIRP), antenna gain, an FCC ID, a CBRS device category and radio type.

18. The RU of claim 11, wherein the measuring plane has a three axis orientation that includes a boresight axis for alignment with the information capture device.
